(19) United States
(12) Patent Application Publication
(10) Pub. No.: US 2026/0268446 A1
(43) Pub. Date: Sep. 10, 2026

(54) IMAGING SYSTEM, IMAGING METHOD, AND RECORDING MEDIUM

(71) Applicant: CANON KABUSHIKI KAISHA, Tokyo (JP)

(72) Inventors: HIROKAZU TAKAHASHI, Tokyo (JP); TATSUAKI AKAHANE, Kanagawa (JP)

(21) Appl. No.: 19/554,228

(22) Filed: Mar. 2, 2026

(30) Foreign Application Priority Data
Mar. 4, 2025 (JP) 2025-033591

(51) Int. Cl. G06T 5/50; G06T 5/70; G06T 5/80; G06T 5/94; H04N 23/698; H04N 23/81; H04N 23/88

(52) U.S. Cl. CPC G06T 5/50; G06T 5/70; G06T 5/80; G06T 5/94; H04N 23/698; H04N 23/81; H04N 23/88; G06T 2207/10024; G06T 2207/20212

(57) ABSTRACT

An imaging system includes a first imaging apparatus, a second imaging apparatus, and an image generation unit configured to generate an image by using a signal output from each of the first imaging apparatus and the second imaging apparatus. The image generation unit is configured to generate a first region in the image by using first correction processing based on the signal output from one of the first imaging apparatus and the second imaging apparatus, and generate a second region on an outer peripheral side of the first region in the image by using second correction processing different from the first correction processing based on the signal output from another one of the first imaging apparatus and the second imaging apparatus.

### BACKGROUND

### Field of the Technology

The present disclosure relates to an imaging system that generates a high-quality image, and the like.

### Description of the Related Art

A head-mounted display is often used for virtual reality (VR) in which a virtual space is displayed such that a wearer experiences the virtual space as if it were real, or mixed reality (MR) in which a virtual object or the like is displayed in a real space. With the head-mounted display, it is possible to limit or operate visual information obtained by the wearer, and to give the wearer a high sense of immersion.

In order to give a higher sense of immersion, a display image with a wide angle of view and a high resolution is required, but such a requirement leads to an increase in the amount of data handled by the head-mounted display. As a result, a delay occurs in image processing and transfer of display data from imaging to display, and a discrepancy occurs between a motion of the wearer and an image displayed on the head-mounted display. Therefore, image processing and apparatus optimization are performed according to human visual characteristics.

JP 2024-16600 A describes that a gazing point of a human is acquired, and processing is executed only in the vicinity of the gazing point in order to save resources in executing noise reduction processing. However, in the method described in JP 2024-16600 A, only one camera is used per one eye of a human, and it is thus necessary to increase a resolution of an imaging element in order to achieve a wide angle of view with a sense of immersion, as a result of which the amount of data to be handled tends to increase.

JP 2017-204674 A and JP 2023-14082 A describe image generation based on human visual characteristics, such as making a resolution of a region of interest high but making a resolution of a peripheral region low in order to reduce the amount of data to be processed. In particular, in the MR that handles data obtained by imaging a real space, a plurality of cameras are used at the time of imaging, a region of interest is imaged with a high resolution, and a peripheral region is imaged with a low resolution. Then, an image of the real space based on the human visual characteristics is acquired by compositing the captured images. However, in a case where the plurality of cameras are used as in JP 2017-204674 A and JP 2023-14082 A, there is an issue in that when the image of the region of interest and the image of the peripheral region are composited using the captured images, a composition boundary is conspicuous due to a difference in noise characteristic and a difference in resolution between the cameras.

One of the solutions by the embodiments disclosed in the present specification and the drawings is to provide a technology for making a composition boundary inconspicuous when an image of a region of interest and an image of a peripheral region are composited to generate a whole image. However, the issue to be solved by the embodiments disclosed in the present specification and the drawings is not limited to the above issue. An issue corresponding to each effect of each configuration described in the embodiments described below can also be regarded as further issues to be considered.

### SUMMARY

According to a first aspect of the present disclosure, an imaging system includes a first imaging apparatus, a second imaging apparatus, and an image generation unit configured to generate an image by using a signal output from each of the first imaging apparatus and the second imaging apparatus. The image generation unit is configured to generate a first region in the image by using first correction processing based on the signal output from one of the first imaging apparatus and the second imaging apparatus, and generate a second region on an outer peripheral side of the first region in the image by using second correction processing different from the first correction processing based on the signal output from another one of the first imaging apparatus and the second imaging apparatus.

According to a second aspect of the present disclosure, an imaging system includes an imaging apparatus configured to acquire a captured image having a different resolution per angle of view between a center region and a peripheral region, and an image generation unit configured to generate an image by using the captured image. The image generation unit is configured to generate a first region in the image by using first correction processing for the center region of the captured image, generate a second region in the image by using second correction processing different from the first correction processing for the peripheral region of the captured image, and composite the first region and the second region to generate the image.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic functional block diagram for illustrating a configuration of a camera system (imaging system) according to a first embodiment.

FIG. 2 is a schematic diagram for describing an arrangement and fields of view of respective imaging apparatuses.

FIG. 3A is a view showing an example of a peripheral image captured by an imaging apparatus.

FIG. 3B is a view showing an example of a left-eye image captured by an imaging apparatus.

FIG. 3C is a view showing an example of an enlarged peripheral image generated as a result of enlarging processing of the peripheral image by an image processing unit.

FIG. 4 is a view for describing that a boundary between the left-eye image and the enlarged peripheral image is conspicuous in a left-eye composite image in a case where correction processing according to the present embodiment is not executed.

FIG. 5A is a view showing an example of the peripheral image captured by the imaging apparatus.

FIG. 5B is a view showing an example of a noise-reduced peripheral image as a result of executing noise reduction processing on the peripheral image by the image processing unit.

FIG. 5C is a view showing an example of a noise-reduced enlarged peripheral image as a result of executing enlargement processing on the noise-reduced peripheral image by the image processing unit.

FIG. 6A is a view showing an example of the left-eye image captured by the imaging apparatus.

FIG. 6B is a view showing an example of a noise-reduced left-eye image as a result of executing the noise reduction processing on the left-eye image by the image processing unit.

FIG. 7 is a view showing an example of an image generated by composition processing executed by a composition processing unit.

FIG. 8 is a flowchart showing a procedure of image processing according to the first embodiment.

FIG. 9 is a schematic functional block diagram for illustrating a configuration of a camera system (imaging system) according to a second embodiment.

FIG. 10 is a view schematically showing a state of optical distortion that occurs in a case where an orthogonal grid that is a subject is imaged via an optical element (for example, a fisheye lens).

FIG. 11 is a view showing an example of an image obtained by imaging an imaging region of FIG. 10 using the imaging apparatus.

FIG. 12 is a view showing an example in which the image processing unit executes the deformation processing for correcting the optical distortion on the captured image shown in FIG. 11.

FIG. 13 is a view showing an example in which different types of noise reduction processing are respectively performed on a center region and a peripheral region.

FIG. 14 is a view showing a result of the deformation processing executed by the image processing unit.

FIG. 15 is a view showing an example in which different types of noise reduction processing are respectively performed on three regions including the center region, an intermediate region, and the peripheral region.

FIG. 16 is a view showing an example in which the deformation processing is executed to generate an image to be displayed on a display apparatus.

FIG. 17 is a flowchart showing a procedure of image processing according to a second embodiment.

FIG. 18A is a view showing an example of a peripheral image captured by an imaging apparatus.

FIG. 18B is a view showing a gain-adjusted peripheral image as a result of executing gain adjustment processing on the peripheral image by an image processing unit.

FIG. 18C is a view showing a gain-adjusted enlarged peripheral image as a result of executing enlargement processing on the gain-adjusted peripheral image by the image processing unit.

FIG. 19A is a view showing an example of a left-eye image captured by an imaging apparatus.

FIG. 19B is a view showing a gain-adjusted left-eye image as a result of executing the gain adjustment processing on the left-eye image by the image processing unit.

FIG. 20 is a view showing a left-eye composite image as a result of composition processing.

FIG. 21 is a flowchart showing a procedure of image processing according to a third embodiment.

FIG. 22A is a schematic diagram for describing equipment according to a fourth embodiment.

FIG. 22B is a diagram showing an example of a photoelectric conversion system related to an in-vehicle camera.

FIG. 22C is a diagram showing the photoelectric conversion system in the case of imaging an area in front of a vehicle.

### DESCRIPTION OF THE EMBODIMENTS

An imaging system, an imaging method, and the like according to embodiments of the present disclosure will be described with reference to the drawings. The embodiments described below are merely examples, and for example, detailed configurations can be appropriately changed and implemented by those skilled in the art without departing from the gist of the present disclosure.

In the drawings referred to in the following embodiments and description, elements denoted by the same reference numerals have similar functions unless otherwise specified. In the drawings, in a case where a plurality of the same elements are arranged, reference numeral and a description thereof may be omitted. In addition, the drawings may be schematic for convenience of illustration and description, and thus, the shape, size, arrangement, and the like of elements in the drawings may not strictly match those of actual ones.

### First Embodiment

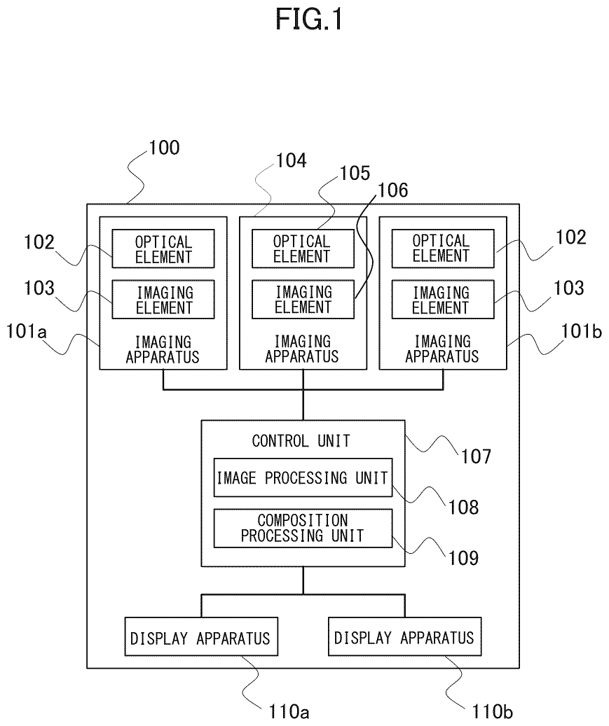

An imaging system according to a first embodiment will be described with reference to FIGS. 1 to 8. In the first embodiment, an imaging apparatus with a narrow angle of view and an imaging apparatus with a wide angle of view are used, different types of noise reduction processing are executed on images acquired by the respective imaging apparatuses, and images suitable for visual field characteristics of a human are composited.

FIG. 1 is a schematic functional block diagram for illustrating a configuration of a camera system (imaging system) according to the first embodiment. A camera system 100 (imaging system) includes an imaging apparatus 101a, an imaging apparatus 101b, an imaging apparatus 104, a control unit 107, a display apparatus 110a, and a display apparatus 110b. The camera system 100 executes composition processing by using images captured by the plurality of imaging apparatuses and outputs a composite image to the display apparatus.

The imaging apparatus 101a includes an optical element 102 and an imaging element 103, and captures an image of a range corresponding to a region of interest of a left eye in human vision. The imaging apparatus 101b includes an optical element 102 and an imaging element 103, and captures an image of a range corresponding to a region of interest of a right eye in human vision. The optical element 102 included in each imaging apparatus is a lens that enables imaging of the range corresponding to the region of interest.

As the imaging element 103, an imaging element including pixels including an element such as a complementary metal oxide semiconductor (CMOS) or a single photon avalanche diode (SPAD) is used. The imaging element 103 captures a subject image incident through the optical element 102. Furthermore, the imaging element 103 may include a filter selecting a predetermined wavelength in each pixel, and may include, for example, red, blue, and green color filters. As for an arrangement of the filters, for example, rows in which the red and green filters are alternately arranged and rows in which the green and blue filters are alternately arranged may be alternately arranged, or other arrangements may be employed. It is desirable that the imaging apparatus 101a and the imaging apparatus 101b include similar optical elements and imaging elements, but the optical elements and the imaging elements are not necessarily similar depending on an application.

The imaging apparatus 104 includes an optical element 105 and an imaging element 106, and captures an image of a range corresponding to a peripheral region in human vision. The optical element 105 is a lens that enables imaging with a wider angle of view than the optical element 102. The imaging element 106 is an imaging element used corresponding to the optical element 105. As the imaging element 106, an imaging element including pixels including an element such as a complementary metal oxide semiconductor (CMOS) or a single photon avalanche diode (SPAD) can be used.

The imaging system may be configured such that the number of pixels per imaging angle of view of the imaging element 106 falls within a range not exceeding the number of pixels per imaging angle of view of the imaging apparatus 101a and the imaging apparatus 101b. For example, in a case where it is assumed that the imaging angle of view of the imaging apparatus 101a and the imaging apparatus 101b is 60 degrees and the number of pixels within the angle of view is 1200 pixels, the number of pixels per angle of view of the imaging apparatuses 101a and 101b is 20 pixels/degree. In this case, for example, the imaging angle of view of the imaging apparatus 104 can be 120 degrees, the number of pixels within the angle of view can be 1200 pixels, and the number of pixels per angle of view can be 10 pixels/degree.

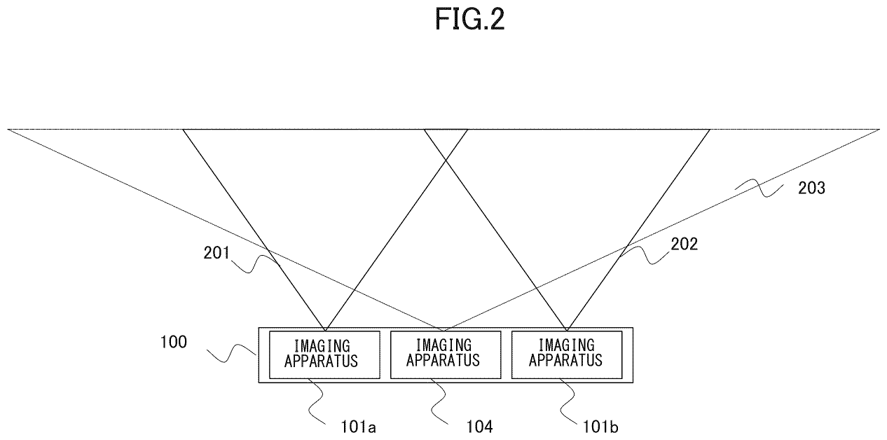

FIG. 2 is a schematic diagram for describing an arrangement and the fields of view of the imaging apparatus 101a, the imaging apparatus 101b, and the imaging apparatus 104. As shown in FIG. 2, the imaging apparatus 104 may be disposed between the imaging apparatus 101a and the imaging apparatus 101b. Furthermore, it may be that the imaging apparatus 101a and the imaging apparatus 101b are disposed apart from each other by a distance corresponding to an inter-pupillary distance (IPD) of a human. A position adjustment mechanism that allows a user to adjust the distance between the imaging apparatus 101a and the imaging apparatus 101b according to the inter-pupillary distance of the user may be provided.

Furthermore, it may be that the three imaging apparatuses are arranged on the same straight line, but such an arrangement is not necessarily required. Imaging directions of the imaging apparatuses (or directions of optical axes of the optical elements of the imaging apparatuses) may be the same directions, but do not have to be the same directions depending on an application.

In FIG. 2, the imaging angle of view of the imaging apparatus 101a is illustrated as an angle of view 201, the imaging angle of view of the imaging apparatus 101b is illustrated as an angle of view 202, and the imaging angle of view of the imaging apparatus 104 is illustrated as an angle of view 203. As shown in FIG. 2, it is desirable to configure the optical element of each imaging apparatus such that the angle of view 203 includes right and left regions covered by the angle of view 201 and the angle of view 202. Furthermore, the optical element of each imaging apparatus may be configured such that the angle of view is variable within a range satisfying the above relationship.

In the above description, an example has been described in which the imaging apparatus 101a captures a center region (a range with a narrow angle of view centered on the optical axis) of a display image for the left eye, and the imaging apparatus 101b captures a center region (a range with a narrow angle of view centered on the optical axis) of a display image for the right eye. Furthermore, an example in which the imaging apparatus 104 captures the peripheral region (a periphery of the center region) of the display image for the left eye or the right eye has been described. However, in the imaging system according to the embodiment, roles and the arrangement of the imaging apparatus 101a, the imaging apparatus 101b, and the imaging apparatus 104 are not necessarily fixed to those in the above-described examples. For example, the role of each imaging apparatus can be changed by changing the arrangement of the imaging apparatuses, changing the angle of view of the optical element, and/or changing a combination of the imaging element and the optical element. For example, the imaging apparatus 101a may change the role so as to capture, at one time, the center region of the display image for the left eye and capture, at another time, the peripheral region, or may make other changes. The control unit 107 controls each imaging apparatus according to the current role settings and arrangement of the respective imaging apparatuses, and executes image processing and image composition by using the images captured by the respective imaging apparatuses.

For convenience, any one of the imaging apparatus 101a, the imaging apparatus 101b, and the imaging apparatus 104 can be referred to as a first imaging apparatus, and another one can be referred to as a second imaging apparatus. In addition, the center region (a range with a narrow angle of view centered on the optical axis) of the display image can be referred to as a first region, and the peripheral region (the periphery of the center region) can be referred to as a second region. In the present embodiment, the first region in the display image is generated based on a signal output from one of the first imaging apparatus and the second imaging apparatus, and the second region on an outer peripheral side of the first region in the display image is generated based on a signal output from another one of the first imaging apparatus and the second imaging apparatus.

Returning to FIG. 1, the control unit 107 will be described. In addition to performing operation control of each imaging apparatus, the control unit 107 has a function as an image generation unit that generates and outputs an image to be displayed on the display apparatus 110a and the display apparatus 110b by using the images captured by the respective imaging apparatuses. The image processing executed by the control unit 107 can include, for example, development processing, correction processing, and the composition processing. Therefore, the control unit 107 includes an image processing unit 108 and a composition processing unit 109 as functional blocks. Each functional block may be implemented by hardware such as a processor, a memory, and an arithmetic circuit, or may be implemented by a computer executing software such as a program stored in a memory.

For example, the image processing unit 108 executes the development processing on a signal (for example, a pixel value) read from each imaging apparatus. The development processing may include crop processing for cutting out (extracting) an effective range, correction processing for image distortion caused by a lens, the noise reduction processing, brightness correction processing, and the like. Furthermore, in a case where a color image is captured via a color mosaic filter, the development processing may include demosaic processing.

The image processing unit 108 executes the development processing on the pixel value read from the imaging apparatus 101a to generate an image for the center region of the left eye, and executes the development processing on the pixel value read from the imaging apparatus 101b to generate an image for the center region of the right eye. The image processing unit 108 generates an image for the peripheral region for each of the left eye and the right eye by using the image captured by the imaging apparatus 104 with a wide angle of view. The image processing unit 108 composites the image for the center region and the image for the peripheral region to generate an image to be displayed for each of the left eye and the right eye. Furthermore, the image processing unit 108 can execute deformation processing according to the angle of view on the image for the left eye and the image for the right eye, and generate an image for a peripheral region of a display screen, for example. The image processing unit 108 may execute deformation processing according to a distance to a target object, which is obtained by a distance measurement unit (not shown) or execute post-deformation interpolation processing.

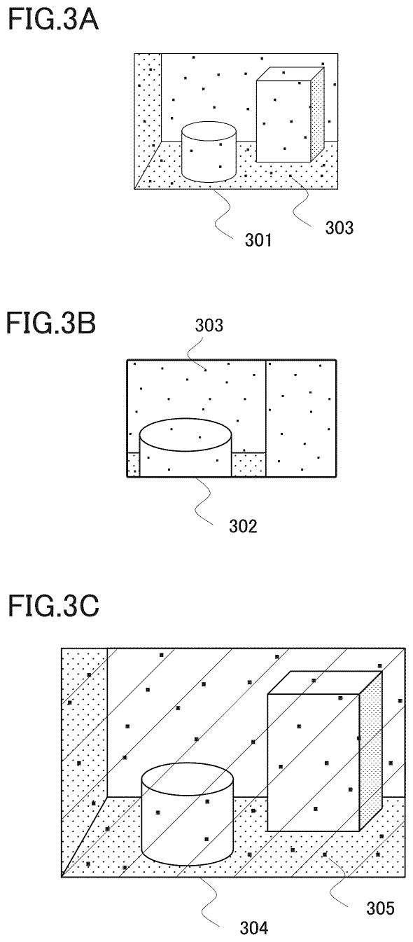

The signal read from the imaging apparatus, that is, a signal before the image processing unit 108 executes processing, will be exemplified. FIG. 3A shows a peripheral image 301 captured by the imaging apparatus 104, and FIG. 3B shows a left-eye image 302 captured by the imaging apparatus 101a. A right-eye image is captured by the imaging apparatus 101b, and a processing procedure therefor is similar to that for the left-eye image 302, and thus illustration and description thereof are omitted. The peripheral image 301 and the left-eye image 302 are different in size of the imaging angle of view, and include noise 303 at a stage of being read from the imaging apparatuses.

In order to be able to composite the peripheral image 301 and the left-eye image 302, the image processing unit 108 executes enlargement processing on the peripheral image 301 captured with a wide angle of view and performs adjustment such that a size of a subject becomes the same as that in the left-eye image 302. FIG. 3C illustrates an enlarged peripheral image 304 generated as a result of executing the enlargement processing on the peripheral image 301 by the image processing unit 108. The enlarged peripheral image 304 obtained by performing enlargement such that the subject has the same size has a relatively lower resolution than the left-eye image 302. In the following illustration, a portion having a relatively lower resolution is indicated by hatching for convenience. In addition, the enlarged peripheral image 304 includes enlarged noise 305 obtained by enlarging the noise 303.

Returning to FIG. 1, the composition processing unit 109 composites the enlarged peripheral image 304 and the left-eye image 302 to generate a left-eye composite image. Furthermore, similar processing is executed for the right-eye image. The display apparatus 110a displays the left-eye composite image obtained by the composition performed by the composition processing unit 109. Similarly, the display apparatus 110b displays a right-eye composite image obtained by the composition performed by the composition processing unit 109. The display apparatus 110a and the display apparatus 110b can be implemented using, for example, a liquid crystal panel or an organic EL panel, but other display devices may also be used. Furthermore, the display apparatus 110a and the display apparatus 110b may be projection-type display apparatuses including the optical elements such as lenses.

In the present embodiment, the correction processing described below is executed in order to make a boundary between the left-eye image 302 and the enlarged peripheral image 304 inconspicuous in the left-eye composite image displayed on the display apparatus 110a. Similarly, the correction processing described below is executed in order to make a boundary between the right-eye image and the enlarged peripheral image inconspicuous in the right-eye composite image displayed on the display apparatus 110b.

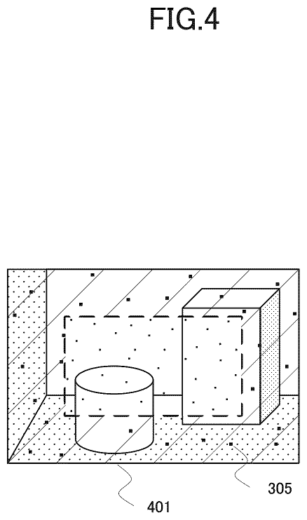

First, it will be described with reference to FIG. 4 that the boundary between the left-eye image 302 and the enlarged peripheral image 304 is conspicuous in the left-eye composite image in a case where the correction processing according to the present embodiment is not executed. The same applies to the right-eye composite image, in which the boundary is conspicuous in the composite image. FIG. 4 shows a left-eye composite image 401 created by a method according to a related art. A rectangular dotted line in the left-eye composite image 401 shows a composition boundary for convenience, and the dotted line does not exist in the actual composite image. A region inside the dotted line corresponds to the left-eye image 302, and a region outside the dotted line corresponds to the enlarged peripheral image 304.

In the left-eye image 302, the noise included in the left-eye image 302 at a stage of being captured is present as it is. On the other hand, the enlarged noise 305 is present in the enlarged peripheral image 304, the enlarged noise 305 being obtained by enlarging the noise 303 included in the peripheral image 301 at the stage of being captured. Since the noise present in the left-eye image 302 and the enlarged noise 305 present in the enlarged peripheral image 304 are different in visual appearance, the boundary between the left-eye image 302 and the enlarged peripheral image 304 is conspicuous for the user.

Therefore, in the present embodiment, the image processing is executed in order to suppress the boundary between the regions from being conspicuous due to a difference in noise characteristic in the composite image. The image processing unit 108 generates the first region in the image by using first correction processing based on the signal output from the first imaging apparatus, and generates the second region on the outer peripheral side of the first region in the image by using second correction processing different from the first correction processing based on the signal output from the second imaging apparatus.

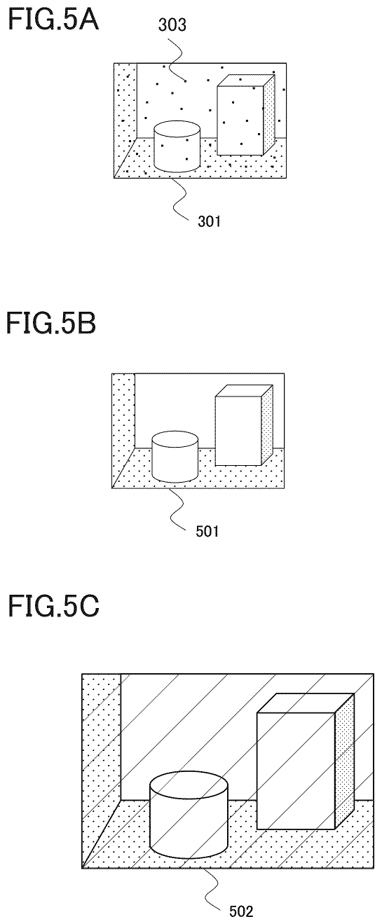

FIG. 5A shows the peripheral image 301 similar to that in FIG. 3A, the peripheral image 301 being captured by the imaging apparatus 104. FIG. 5B shows a noise-reduced peripheral image 501 as a result of executing the noise reduction processing on the peripheral image 301 by the image processing unit 108. A known method can be used for the noise reduction processing, and for example, there are methods such as detection and replacement of isolated points and superimposition of a plurality of frames. In executing the noise reduction processing, there are parameters related to an execution intensity (processing intensity), such as a threshold for isolated point detection and the number of superimposed frames. In a case where the execution intensity is excessively high, adverse effects may occur. For example, the noise reduction processing is applied to a texture that is not actually noise, or image display delay or afterimage occurs due to frame superimposition. Focusing on a characteristic that the above-described adverse effects are easily tolerated because a peripheral portion after image composition is not a gaze region of a human, in the present embodiment, the execution intensity (processing intensity) for the peripheral image 301 is increased. Therefore, there is substantially no noise in the noise-reduced peripheral image 501 illustrated in FIG. 5B due to the noise reduction processing.

FIG. 5C shows a noise-reduced enlarged peripheral image 502 as a result of executing the enlargement processing on the noise-reduced peripheral image 501 by the image processing unit 108. Similarly to FIG. 3C described above, the enlargement processing is executed at a magnification at which the size of the subject becomes the same as that in the left-eye image 302 at the time of composition. In addition, a portion having a low resolution is indicated by hatching for convenience.

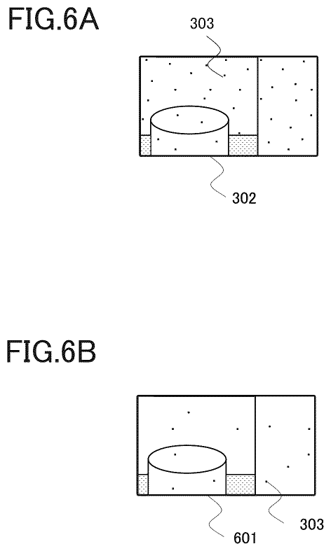

The noise reduction processing for the left-eye image 302 will be described with reference to FIGS. 6A and 6B. FIG. 6A shows the left-eye image 302 similar to that in FIG. 3B, the left-eye image 302 being captured by the imaging apparatus 101a. FIG. 6B shows a noise-reduced left-eye image 601 as a result of executing the noise reduction processing on the left-eye image 302 by the image processing unit 108. Here, since the noise-reduced left-eye image 601 is applied to a portion that becomes the gaze region of a human after image composition, the above-described adverse effects tend to be noticeable when the execution intensity (processing intensity) of the noise reduction processing is excessively high. Therefore, the intensity of the noise reduction processing is made relatively lower than that for the peripheral image, or an effect of the noise reduction processing is substantially reduced. In FIG. 6B, in order to show that the processing intensity of the noise reduction is low, a part of the noise 303 is left for convenience.

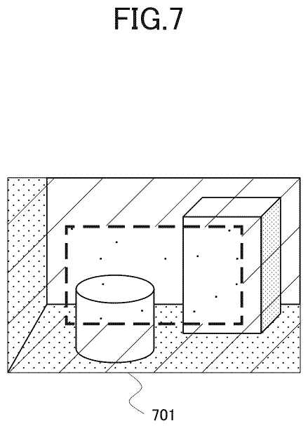

As described above, the image processing unit 108 executes different types of noise reduction processing on the peripheral region and the center region, respectively, and generates the noise-reduced enlarged peripheral image 502 and the noise-reduced left-eye image 601. Once the two images are generated, the composition processing unit 109 executes the composition processing of compositing the images. FIG. 7 illustrates a left-eye composite image 701 (whole image or display image) generated by the composition processing. A dotted line in the left-eye composite image 701 is added for convenience to indicate a composition boundary, and the dotted line does not actually exist in the composite image. A region inside the dotted line corresponds to the noise-reduced left-eye image 601, and a region outside the dotted line corresponds to the noise-reduced enlarged peripheral image 502.

As described above, for the peripheral region outside the dotted line, the noise reduction processing with a higher intensity is executed to reduce visibility of graininess of the noise. In addition, the noise reduction processing with a lower intensity is executed on the gaze region inside the dotted line, and the noise is moderately reduced. When the two images are composited, the image composition boundary portion that is conspicuous particularly due to the graininess of the noise in the peripheral region becomes less conspicuous than that according to the related art. The composition processing unit 109 may execute blend processing or the like by using the pixel value of each image for the boundary portion of the image.

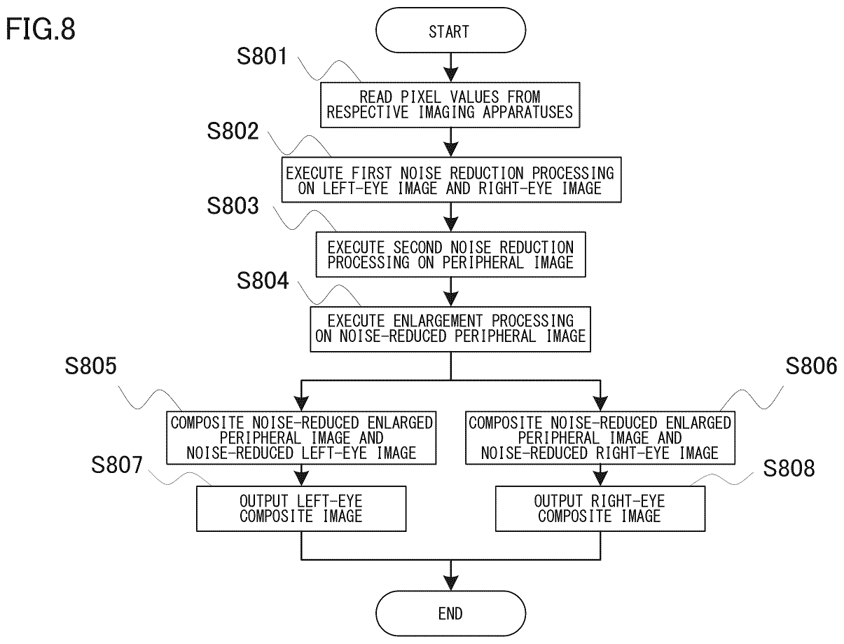

FIG. 8 is a flowchart showing a procedure of the image processing (imaging method) executed by the control unit 107. Steps S802 to S804 are executed by the image processing unit 108 in the control unit 107, and steps S805 and S806 are executed by the composition processing unit 109 in the control unit 107.

First, in step S801, the control unit 107 reads the captured images (pixel values) from the respective imaging apparatuses. Next, in step S802, the first noise reduction processing is executed on the left-eye image 302 and the right-eye image (not shown) among the read captured images to generate the noise-reduced left-eye image 601 and a noise-reduced right-eye image (not shown). In step S803, the second noise reduction processing is executed on the peripheral image 301 among the read captured images to generate the noise-reduced peripheral image 501. In step S804, the enlargement processing is executed on the noise-reduced peripheral image 501 to generate the noise-reduced enlarged peripheral image 502. Steps S802 to S804 are not necessarily executed in this order, and the order may be changed, or steps S802 to S804 may be executed in parallel at the same time.

In step S805, the noise-reduced enlarged peripheral image 502 and the noise-reduced left-eye image 601 are composited to generate the left-eye composite image 701. In step S806, the same processing as in step S805 is also executed on the right-eye image (not shown). In step S807, the left-eye composite image 701 is output. In step S808, the right-eye composite image is output. In FIG. 8, after step S804, the processing branches into two steps, step S805 and step S806, but the two steps may be executed in parallel at the same time, or may be executed in series as long as there is no problem in display.

As described above, with the camera system of the first embodiment, when images captured by different imaging apparatuses are composited into one image, different types of noise reduction processing are executed on the center region at which a human gazes and the peripheral region, respectively. As a result, it is possible to generate an image in which the composition boundary is inconspicuous and a sense of discomfort is small. Specifically, image processing in which priority is given to decreasing the intensity of the noise reduction processing to suppress texture overcorrection and display delay is executed on a region at which a human gazes, and image processing in which priority is given to increasing the intensity of the noise reduction processing to reduce the visibility of the graininess is executed on the peripheral region. That is, according to the present embodiment, it is possible to provide a technology for making the composition boundary inconspicuous when the image of the center region and the image of the peripheral region are composited to generate the whole image.

### Second Embodiment

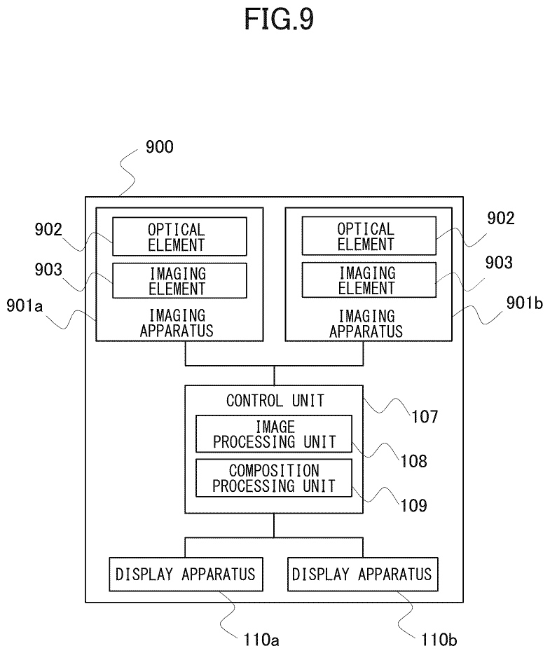

An imaging system according to a second embodiment will be described with reference to FIGS. 9 to 17. A description of matters common to the first embodiment will be simplified or omitted. In the first embodiment, an imaging apparatus with a narrow angle of view and an imaging apparatus with a wide angle of view are used, different types of noise reduction processing are executed on images acquired by the respective imaging apparatuses, and images suitable for visual field characteristics of a human are composited.

On the other hand, in the second embodiment, an imaging apparatus equipped with, for example, a fisheye lens capable of imaging at a wide angle is provided, and different types of noise reduction processing are executed on a center region and a peripheral region of a captured image, respectively. Different types of noise reduction processing suitable for visual field characteristics of a human are executed on the captured image, and images resulting therefrom are composited to generate, for example, a display image.

FIG. 9 is a schematic functional block diagram for illustrating a configuration of a camera system (imaging system) according to the second embodiment. A camera system 900 includes an imaging apparatus 901a, an imaging apparatus 901b, a control unit 107, a display apparatus 110a, and a display apparatus 110b. The camera system 900 generates an image suitable for human visual characteristics by using the image captured by the imaging apparatus, and outputs the image to the display apparatus.

The imaging apparatus 901a includes an optical element 902 and an imaging element 903, and captures an image for a left eye of a human. The imaging apparatus 901b includes an optical element 902 and an imaging element 903, and captures an image for a right eye of a human. The optical element 902 included in each imaging apparatus is, for example, a fisheye lens that enables imaging with a wide angle, and has optical characteristics in which distortion of a subject image is particularly large at a peripheral portion of an angle of view.

The control unit 107 generates the image for the left eye of the human by using the image captured by the imaging apparatus 901a, and causes the display apparatus 110a for the left eye to display the image. Similarly, the control unit 107 generates the image for the right eye of the human using the image captured by the imaging apparatus 901b, and causes the display apparatus 110b for the right eye to display the image. Image processing described below is assumed to be executed in the same procedure for the right-eye image and the left-eye image.

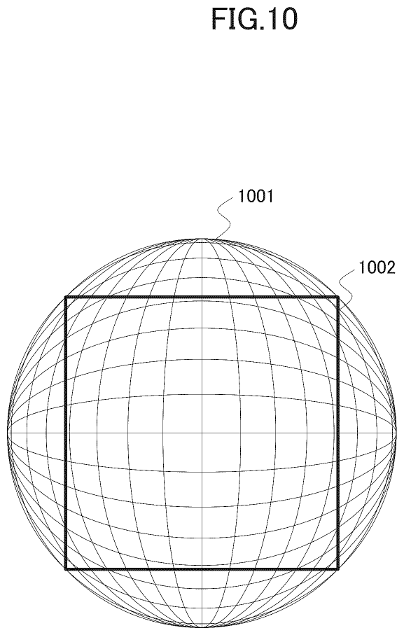

FIG. 10 schematically shows a state of optical distortion that occurs in a case where an orthogonal grid 1001 that is a subject is imaged via the optical element 902 (for example, the fisheye lens). An imaging region 1002 indicates a range imaged by the imaging element 903.

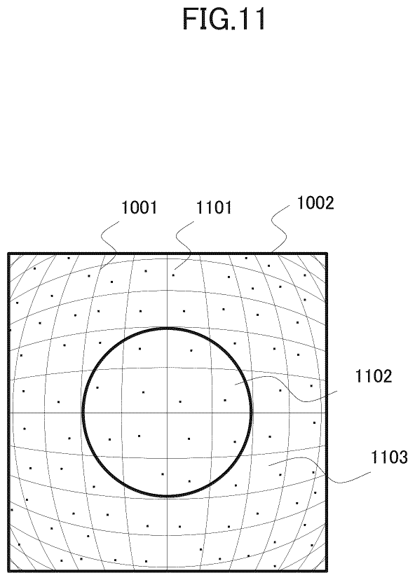

FIG. 11 shows an image obtained by imaging the imaging region 1002 of FIG. 10 using the imaging element 903, and the image includes noise 1101 together with the grid 1001. A circular solid line indicates a boundary between a center region 1102 serving as a first portion and a peripheral region 1103 serving as a second portion, and is added for convenience, and does not actually exist in the captured image. The center region 1102 is a region that is a gaze region of a human, and is a region in which optical distortion in the fisheye lens is small and which can be used without executing deformation processing for correcting the distortion with a high intensity. The peripheral region 1103 is a region that is not the gaze region of a human, and is a region in which the optical distortion by the fisheye lens is large, and the deformation processing for correcting the distortion is required. The center region 1102 is not necessarily set to have a circular shape as shown in FIG. 11, and may be an elliptical or rectangular region.

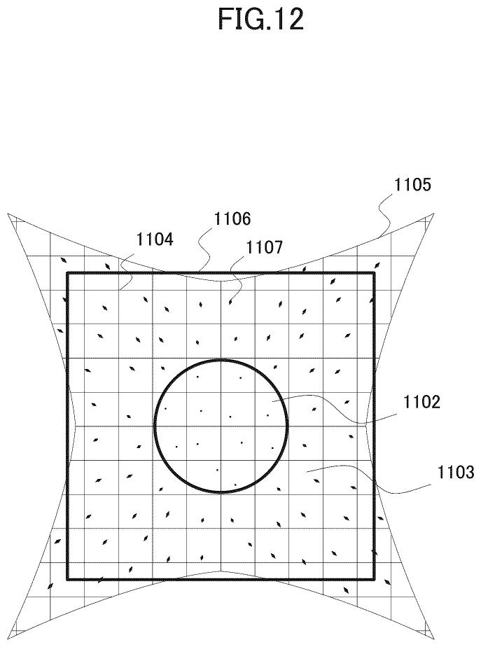

FIG. 12 illustrates a result of executing, by an image processing unit 108, the deformation processing for correcting the optical distortion on the captured image shown in FIG. 11. The deformation processing does not have to necessarily be executed on the center region 1102, or the deformation processing may be executed with a low distortion correction intensity. Therefore, the image processing unit 108 executes different types of correction processing separately for the center region 1102 and the peripheral region 1103, and then a composition processing unit 109 composites the center region 1102 and the peripheral region 1103 to generate a composite image. That is, the image processing unit 108 executes the deformation processing on the peripheral region 1103 with a higher distortion correction intensity than that for the center region 1102. FIG. 12 illustrates an image as a result of the composition processing executed by the composition processing unit 109.

The grid 1001 imaged as illustrated in FIG. 11 is corrected to an orthogonal grid 1104 as illustrated in FIG. 12 by the deformation processing for correcting the optical distortion. The imaging region 1002 having a rectangular outer shape as shown in FIG. 11 is deformed into a post-deformation-processing imaging region 1105 shown in FIG. 12 by the deformation processing. A rectangular region 1106 is cut out from the post-deformation-processing imaging region 1105 according to a shape of a display screen of the display apparatus, and is transmitted to the display apparatus as display image data. Therefore, data of an end portion protruding from the rectangular region 1106 in the corrected image protrudes from the display screen and is thus not used for display.

The noise 1101 existing in the peripheral region 1103 of the captured image (FIG. 11) is deformed by the deformation processing and becomes post-deformation-processing noise 1107 schematically shown in FIG. 12. The degree of deformation increases toward the outside of the screen, and the noise becomes more conspicuous toward the outside of the screen. Since the post-deformation-processing noise 1107 has a visual characteristic different from that of the noise existing in the center region 1102 where the deformation processing is unnecessary, the boundary between the center region 1102 and the peripheral region 1103 becomes conspicuous.

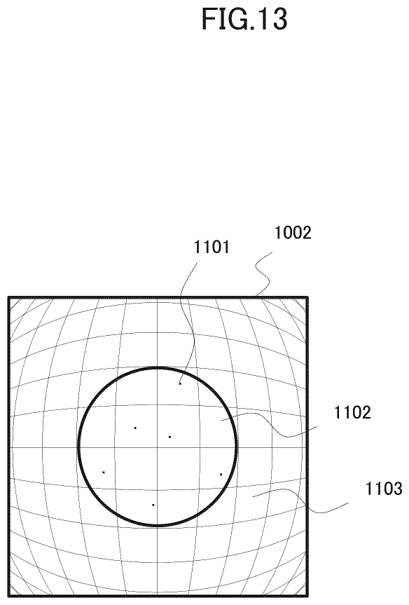

Therefore, in the present embodiment, the image processing unit 108 executes appropriate noise reduction processing in order to suppress the boundary between the center region 1102 and the peripheral region 1103 from being conspicuous in the image composited after the deformation processing. FIG. 13 shows a state in which different types of noise reduction processing are executed on the center region 1102 and the peripheral region 1103, respectively.

As described in the first embodiment, in executing the noise reduction processing, there are parameters related to an execution intensity (processing intensity and noise reduction intensity), such as a threshold for isolated point detection and the number of superimposed frames. For the peripheral region 1103 that is not the gaze region of a human, even if the execution intensity (processing intensity and noise reduction intensity) is increased, effective adverse effects are small. Therefore, for the peripheral region 1103, the execution intensity of the noise reduction processing is increased, and the noise hardly remains after the processing. On the other hand, when the execution intensity of the noise reduction processing is excessively high, the adverse effects tend to be noticeable in the center region 1102 that is the gaze region of a human, and thus, the execution intensity of the noise reduction processing is made relatively low, or the effect of the noise reduction processing is substantially reduced. FIG. 13 schematically shows a state in which a part of the noise 1101 is left in order to show that the intensity of the noise reduction processing of the center region 1102 is low.

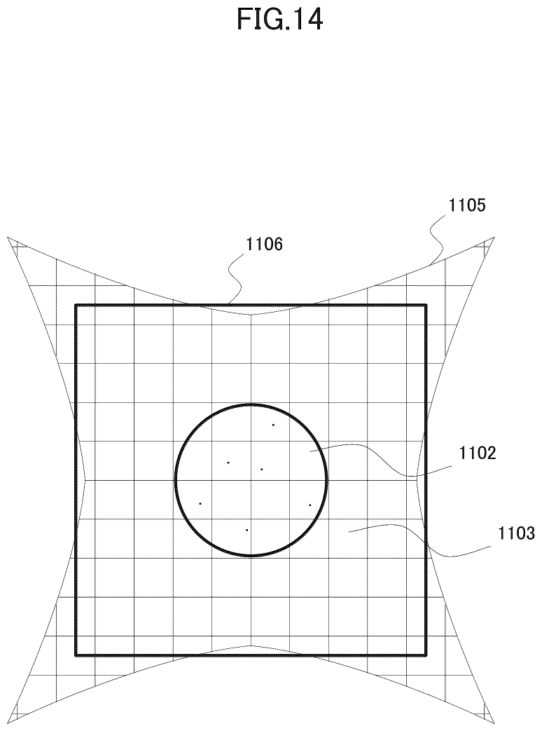

The image processing unit 108 executes the deformation processing for correcting the optical distortion on the image shown in FIG. 13 in which different types of noise reduction processing have been executed on the center region 1102 and the peripheral region 1103, respectively. FIG. 14 illustrates a result of executing the deformation processing by the image processing unit 108. The deformation processing does not have to necessarily be executed on the center region 1102, or the deformation processing may be executed with a low distortion correction intensity. Therefore, the image processing unit 108 executes different types of deformation processing separately for the center region 1102 and the peripheral region 1103, and then the composition processing unit 109 composites the center region 1102 and the peripheral region 1103 to generate the composite image. FIG. 14 illustrates an image as a result of the composition processing executed by the composition processing unit 109.

The grid imaged as illustrated in FIG. 13 is corrected to an orthogonal grid as illustrated in FIG. 14 by the deformation processing for correcting the optical distortion. The imaging region 1002 having a rectangular outer shape as shown in FIG. 13 is deformed into a post-deformation-processing imaging region 1105 shown in FIG. 14 by the deformation processing. A rectangular region 1106 is cut out from the post-deformation-processing imaging region 1105 according to the display screen of the display apparatus, and is transmitted to the display apparatus as the display image data. Therefore, data of a significantly deformed end portion in the corrected image protrudes from the rectangular display screen and is thus not used for the display image.

A solid circle in the composite image is added for convenience to indicate the composition boundary, and does not actually exist in the composite image. For the peripheral region 1103 of the composite image, the intensity of the noise reduction processing is increased, so that visibility of graininess of the noise is reduced. Furthermore, for the center region 1102 that is the gaze region, the intensity of the noise reduction processing is relatively low, and moderate noise reduction is performed. In the present embodiment, the visibility of the graininess of noise is particularly reduced in the peripheral region, and thus the boundary between the regions, which is conspicuous when the center region and the peripheral region are composited, is less likely to be conspicuous. The composition processing unit 109 may execute blend processing or the like by using a pixel value of each image for the boundary portion of the image.

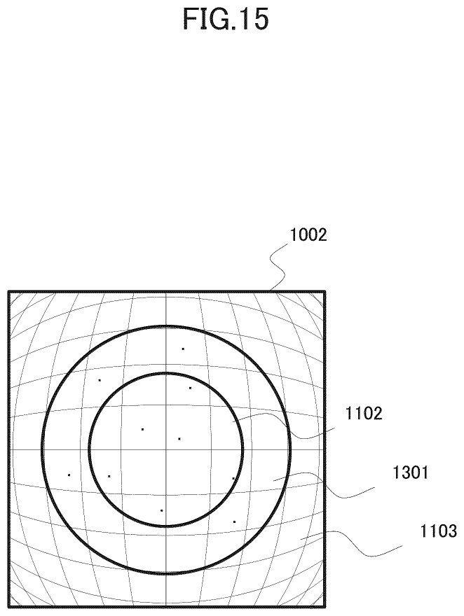

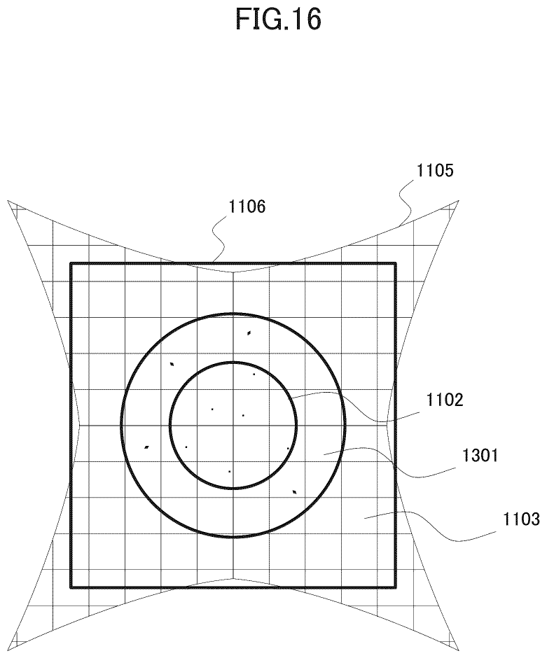

In the example shown in FIG. 12, the captured image is divided into two regions, the center region 1102 and the peripheral region 1103, and the center region 1102 and the peripheral region 1103 are subjected to different types of correction processing and then composited. However, the number of regions is not limited to two, and the correction processing and the composition may be performed by dividing the captured image into a larger number of regions. For example, in the example shown in FIG. 15, the captured image is divided into three regions, a center region 1102 serving as the first portion, an intermediate region 1301 (third region) serving as a third portion, and the peripheral region 1103 serving as the second portion. For the center region 1102, the noise reduction processing with a low intensity is executed as first correction processing, for the peripheral region 1103, the noise reduction processing with a high intensity is executed as second correction processing, and for the intermediate region 1301, the noise reduction processing with an intermediate intensity is executed as third correction processing. FIG. 15 shows a state in which the noise reduction processing is executed, and FIG. 16 shows a state in which the deformation processing is executed to generate an image to be displayed on the display apparatus.

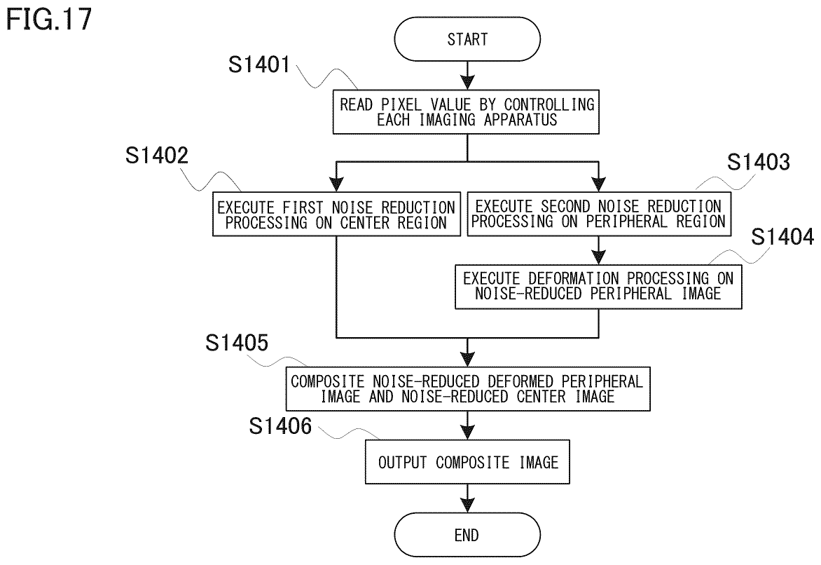

FIG. 17 is a flowchart showing a procedure of the image processing executed by the control unit 107. Each step of processing is executed by the control unit 107. In particular, steps S1401 to S1404 are executed by the image processing unit 108 in the control unit 107, and steps S1405 and S1406 are executed by the composition processing unit 109 in the control unit 107.

In step S1401, the control unit 107 reads the pixel value from each imaging apparatus. In step S1402, the first noise reduction processing is executed on the center region of the read image to generate a noise-reduced center image. In step S1403, the second noise reduction processing is executed on the peripheral region of the read image to generate a noise-reduced peripheral image. In step S1404, the deformation processing is executed on the noise-reduced peripheral image to generate a noise-reduced deformed peripheral image. Although a case where the deformation processing is not executed on the noise-reduced center image is exemplified, the deformation processing having a lower distortion correction intensity than that executed on the noise-reduced peripheral image may be executed on the noise-reduced center image.

In step S1405, the noise-reduced deformed peripheral image and the noise-reduced center image are composited to generate a composite image. In step S1406, the composite image is output. In FIG. 17, after step S1401, the processing branches into two steps, step S1402 and step S1403, but the two steps do not necessarily have to be executed in parallel at the same time, and the two steps may be executed in series.

As described above, with the camera system of the second embodiment, different types of noise reduction processing are executed on the center region at which a human gazes and the peripheral region, respectively, for the captured image obtained through an optical system having different optical characteristics in a center region and a peripheral region. Therefore, when the center region and the peripheral region are composited, it is possible to generate an image in which the boundary is not conspicuous and a sense of discomfort is small. Specifically, image processing in which priority is given to decreasing the intensity of the noise reduction processing to reduce texture overcorrection and display delay is executed on a region at which a human gazes, and image processing in which priority is given to increasing the intensity of the noise reduction processing to reduce the visibility of the graininess at the composition boundary is executed on the peripheral region. That is, according to the present embodiment, it is possible to provide a technology for making the composition boundary inconspicuous when the image of the center region and the image of the peripheral region are composited to generate the whole image.

### Third Embodiment

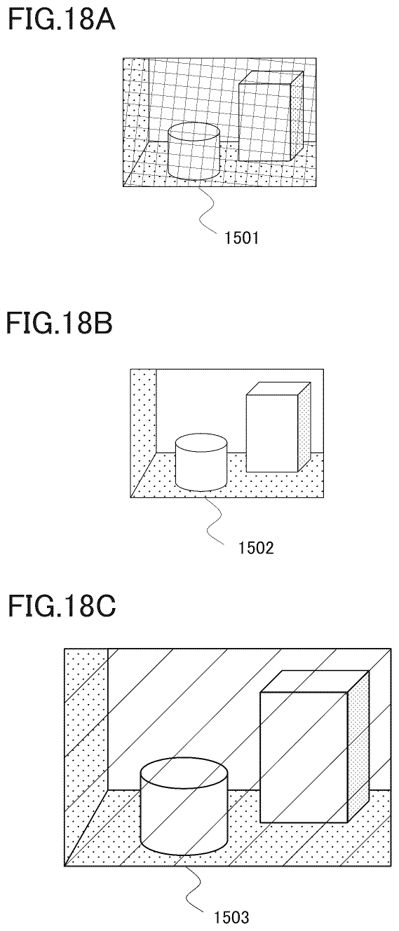

An imaging system according to a third embodiment will be described with reference to FIGS. 18A to 21. A description of matters common to the first or second embodiment will be simplified or omitted. The imaging system according to the present embodiment has the configurations shown in FIGS. 1 and 2 similarly to the first embodiment. An imaging apparatus 101a captures a left-eye image, an imaging apparatus 101b captures a right-eye image, and an imaging apparatus 104 captures a peripheral image. In the present embodiment, an image processing unit 108 is configured to be able to execute image processing different from noise reduction processing, for example, gain adjustment processing.

In the present embodiment, the gain adjustment processing and enlargement processing executed by the image processing unit 108 will be described. FIG. 18A illustrates a peripheral image 1501 captured by the imaging apparatus 104. In FIG. 18A, a portion having a low luminance is expressed with shading, indicating that gain adjustment is necessary.

FIG. 18B shows a gain-adjusted peripheral image 1502 as a result of executing the gain adjustment processing on the peripheral image 1501 by the image processing unit 108. As the gain adjustment processing, a method of performing nonlinear conversion on a pixel value or a method of changing a gain according to an angle of view may be used other than a method of performing uniform adjustment on the image.

FIG. 18C shows a gain-adjusted enlarged peripheral image 1503 as a result of executing the enlargement processing on the gain-adjusted peripheral image 1502 by the image processing unit 108. Similarly to the first embodiment, the enlargement processing is executed such that a size of a subject becomes the same as that in a center region image captured by another imaging apparatus in composition processing to be executed later. In FIG. 18C, a portion having a low resolution is indicated by hatching added for convenience.

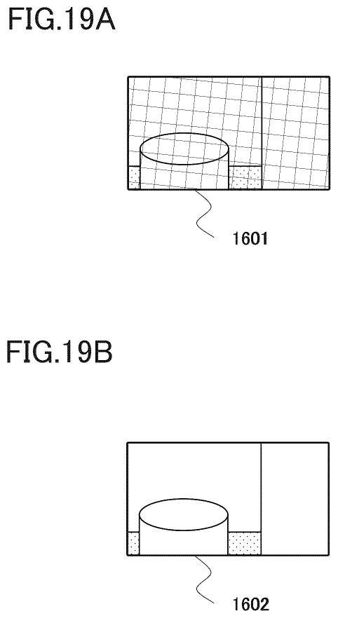

FIG. 19A shows a left-eye image 1601 captured by the imaging apparatus 101a. Similarly to FIG. 18A, a portion having a low luminance is indicated by shading for convenience. Since the left-eye image 1601 is captured by the imaging apparatus 101a different from the imaging apparatus 104, a luminance characteristic in FIG. 19A is different from that in FIG. 18A.

FIG. 19B shows a gain-adjusted left-eye image 1602 as a result of executing the gain adjustment processing on the left-eye image 1601 by the image processing unit 108. Here, a parameter applied to the gain adjustment is changed from a parameter applied to the peripheral image 1501 captured by another imaging apparatus, and a luminance and/or contrast of the image is adjusted such that a boundary becomes inconspicuous when the composition processing is executed later.

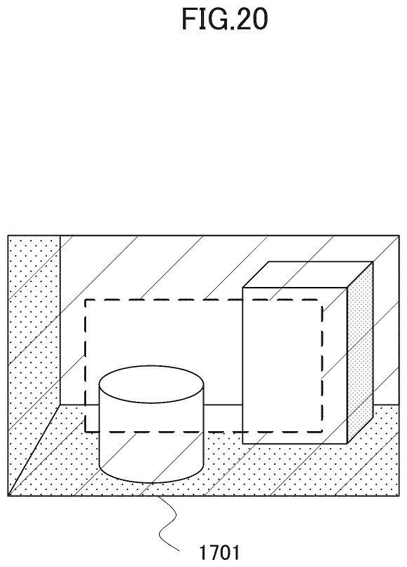

When the image processing unit 108 generates the gain-adjusted enlarged peripheral image 1503 and the gain-adjusted left-eye image 1602, a composition processing unit 109 executes the composition processing. FIG. 20 illustrates a left-eye composite image 1701 generated as a result of the composition processing. A dotted line in the left-eye composite image 1701 is added for convenience to indicate the composition boundary, and the dotted line does not exist in the actual composite image. A region inside the dotted line is the gain-adjusted left-eye image 1602, and a region outside the dotted line is the gain-adjusted enlarged peripheral image 1503.

As described above, images are corrected by applying different gain adjustment parameters to captured images acquired by different imaging apparatuses, thereby generating a composite image. For example, correction processing of adjusting the luminance and/or contrast is executed in order to make the image composition boundary inconspicuous for one subject. As in the first embodiment, the composition processing unit 109 may execute blend processing or the like by using a pixel value of each image for the boundary portion of the image.

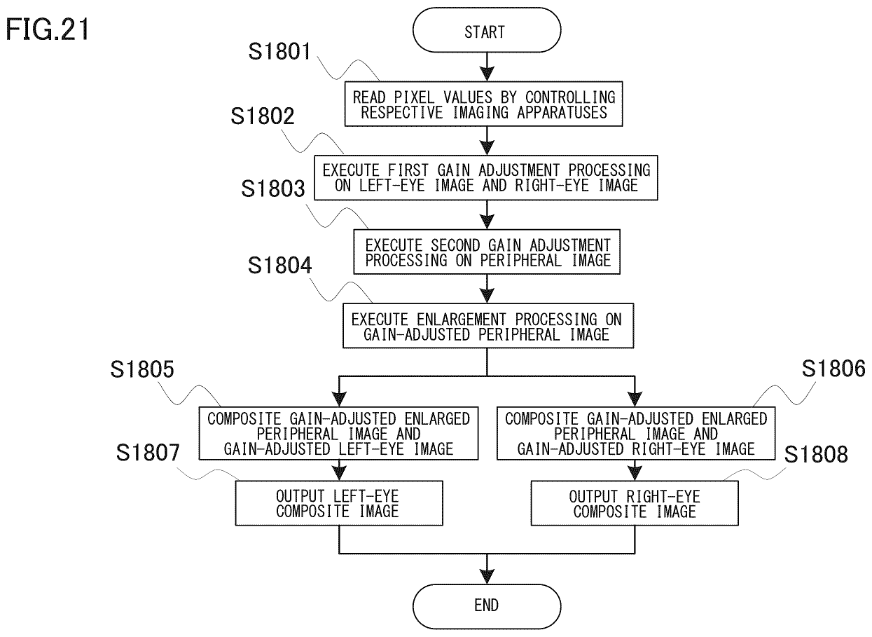

FIG. 21 is a flowchart showing a procedure of the image processing executed by a control unit 107. Each step of processing is executed by the control unit 107. In particular, steps S1802 to S1804 are executed by the image processing unit 108 in the control unit 107, and steps S1805 and S1806 are executed by the composition processing unit 109 in the control unit 107.

First, in step S1801, the control unit 107 reads the captured images (pixel values) from the respective imaging apparatuses. In step S1802, the image processing unit 108 executes first gain adjustment processing on the left-eye image 1601 and the right-eye image (not shown) among the read images, and generates the gain-adjusted left-eye image 1602 and a gain-adjusted right-eye image (not shown). In step S1803, the image processing unit 108 executes second gain adjustment processing on the peripheral image 1501 among the read images to generate the gain-adjusted peripheral image 1502. In step S1804, the image processing unit 108 executes the enlargement processing on the gain-adjusted peripheral image 1502 to generate the gain-adjusted enlarged peripheral image 1503. Steps S1802 to S1804 are not necessarily executed in this order, and the order may be changed.

In step S1805, the composition processing unit 109 composites the gain-adjusted enlarged peripheral image 1503 and the gain-adjusted left-eye image 1602 to generate the left-eye composite image 1701. In step S1806, the same processing as in step S1805 is also executed on the right-eye image (not shown). In step S1807, the left-eye composite image 1701 is output. In step S1808, a right-eye composite image (not shown) is output. In FIG. 21, after step S1804, the processing branches into two steps, step S1805 and step S1806, but the two steps may be executed in parallel at the same time, or may be executed in series as long as there is no problem in display.

As described above, with the camera system of the third embodiment, when images captured by different imaging apparatuses are composited into one image, different types of gain adjustment processing are executed on a center region at which a human gazes and a peripheral region, respectively. As a result, according to the present embodiment, it is possible to provide a technology for making the composition boundary inconspicuous when the image of the center region and the image of the peripheral region are composited to generate the whole image.

### Fourth Embodiment

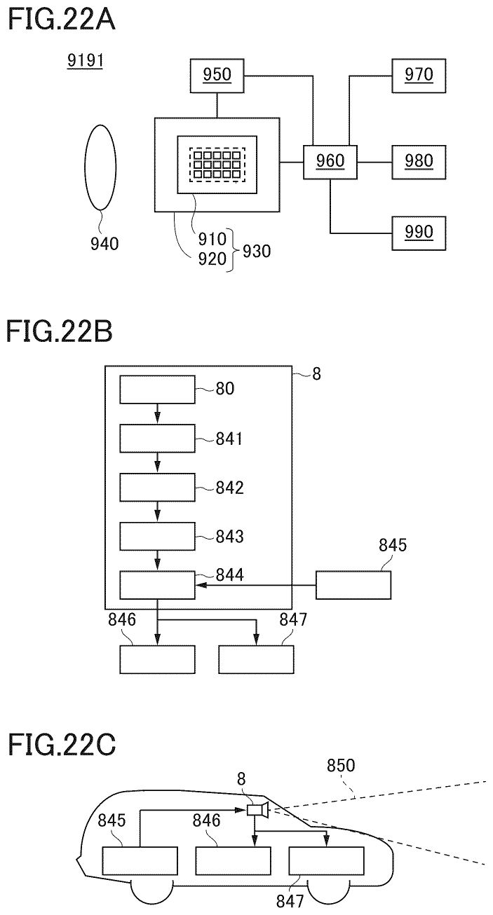

As a fourth embodiment, equipment including the imaging system (imaging apparatus) according to any one of the above-described embodiments will be described. FIG. 22A is a schematic diagram for describing equipment 9191 including an imaging apparatus 930 (imaging system) according to the above-described embodiment. The equipment 9191 including the imaging apparatus 930 will be described in detail.

The imaging apparatus 930 is the imaging system (imaging apparatus) according to any one of the first to third embodiments. The imaging apparatus 930 may include a semiconductor device 910 and a package 920 that houses the semiconductor device 910. The package 920 can include a base to which the semiconductor device 910 is fixed and a lid such as glass that faces the semiconductor device 910. The package 920 can further include a bonding member such as a bonding wire or a bump that connects a terminal provided on the base and a terminal provided on the semiconductor device 910.

The equipment 9191 can include at least one of an optical apparatus 940, a control apparatus 950, a processing apparatus 960, a display apparatus 970, a storage apparatus 980, and a mechanical apparatus 990. The optical apparatus 940 is, for example, a lens, a shutter, or a mirror provided corresponding to the imaging apparatus 930. The control apparatus 950 controls the imaging apparatus 930. The control apparatus 950 is, for example, a semiconductor apparatus such as an application specific integrated circuit (ASIC).

The processing apparatus 960 processes a signal output from the imaging apparatus 930. The processing apparatus 960 is a semiconductor apparatus such as a central processing unit (CPU) or an ASIC for configuring a digital front end (DFE). The display apparatus 970 is an EL display apparatus or a liquid crystal display apparatus that displays information (image) obtained by the imaging apparatus 930. The storage apparatus 980 is a magnetic device or a semiconductor device that stores information (image) obtained by the imaging apparatus 930. The storage apparatus 980 is a volatile memory such as a static random-access memory (SRAM) or a dynamic random-access memory (DRAM), or a nonvolatile memory such as a flash memory or a hard disk drive.

The mechanical apparatus 990 includes a movable unit or a propulsion unit such as a motor or an engine. In the equipment 9191, a signal output from the imaging apparatus 930 is displayed on the display apparatus 970 or is transmitted to the outside by a communication apparatus (not shown) included in the equipment 9191. Therefore, the equipment 9191 may further include the storage apparatus 980 and the processing apparatus 960 separately from a storage circuit and an arithmetic circuit of the imaging apparatus 930. The mechanical apparatus 990 may be controlled based on a signal output from the imaging apparatus 930.

Furthermore, the equipment 9191 is suitable for electronic equipment such as an information terminal (for example, a smartphone or a wearable terminal) having an imaging function or a camera (for example, an interchangeable lens camera, a compact camera, a video camera, or a surveillance camera). The mechanical apparatus 990 in the camera can drive components of the optical apparatus 940 for zooming, focusing, and shutter operations. Alternatively, the mechanical apparatus 990 in the camera can move the imaging apparatus 930 for a vibration-proof operation.

Furthermore, the equipment 9191 may be transportation equipment such as a vehicle, a ship, or a flying body. The mechanical apparatus 990 in the transportation equipment can be used as a movement apparatus. The equipment 9191 serving as the transportation equipment is suitable for transporting the imaging apparatus 930 and assisting and/or automating driving (steering) by the imaging function. The processing apparatus 960 for assisting and/or automating the driving (steering) can perform processing for operating the mechanical apparatus 990 serving as the movement apparatus based on information obtained by the imaging apparatus 930. Alternatively, the equipment 9191 may be medical equipment such as an endoscope, measurement equipment such as a distance measurement sensor, analytical equipment such as an electron microscope, office equipment such as a copying machine, or industrial equipment such as a robot. According to the above-described embodiment, it is possible to stably acquire an image obtained by effectively correcting distortion of a captured image. In addition, by performing different types of correction processing on the center region at which a human gazes and the peripheral region, respectively, the composition boundary can be made inconspicuous when the image of the center region and the image of the peripheral region are composited to generate the whole image.

Therefore, if the imaging apparatus 930 according to the present embodiment is used for the equipment 9191, the value of the equipment can also be improved. For example, it is possible to obtain excellent performance when the imaging apparatus 930 is mounted on the transportation equipment and performs imaging of the outside of the transportation equipment or measurement of an external environment. Therefore, in manufacturing and selling the transportation equipment, it is advantageous to determine to mount the semiconductor apparatus according to the present embodiment on the transportation equipment in order to enhance the performance of the transportation equipment itself. In particular, the imaging apparatus 930 is suitable for transportation equipment that performs driving assistance and/or automated driving of the transportation equipment by using information obtained by the semiconductor apparatus. Implementation in a vehicle, a ship, a flying body, and the like is not limited to application to equipment practically used for transportation purposes, and can be suitably applied to, for example, a drone or the like that performs aerial imaging for various purposes including inspection of buildings and agricultural facilities, monitoring of natural phenomena, and the like.

A photoelectric conversion system and a mobile body according to the present embodiment will be described with reference to FIGS. 22B and 22C. FIG. 22B shows an example of the photoelectric conversion system related to an in-vehicle camera. A photoelectric conversion system 8 includes a photoelectric conversion apparatus 80. The photoelectric conversion apparatus 80 is the photoelectric conversion apparatus serving as an electronic component included in the imaging system 100 described in the above-described embodiment. The photoelectric conversion system 8 includes an image processing unit 841 (image generation unit 7) that performs image processing on a plurality of pieces of image data acquired by the photoelectric conversion apparatus, and a parallax acquisition unit 842 (phase difference detection unit 62) that calculates a parallax (a phase difference of a parallax image) from the plurality of pieces of image data acquired by the photoelectric conversion system 8. Furthermore, the photoelectric conversion system 8 includes a distance acquisition unit 843 that calculates a distance to a target object based on the calculated parallax, and a collision determination unit 844 that determines whether or not there is a possibility of collision based on the calculated distance. Here, the parallax acquisition unit 842 and the distance acquisition unit 843 are examples of a distance information acquisition unit that acquires distance information to the target object. That is, the distance information is information regarding the parallax, a defocus amount, the distance to the target object, and the like. The collision determination unit 844 may determine the possibility of collision by using any one of these pieces of distance information. The distance information acquisition unit may be implemented by dedicated hardware or may be implemented by a software module. Alternatively, the distance information acquisition unit may be implemented by a field programmable gate array (FPGA), an application specific integrated circuit (ASIC), or the like.

The photoelectric conversion system 8 is connected to a vehicle information acquisition apparatus 845, and can acquire vehicle information such as a vehicle speed, a yaw rate, and a steering angle. In addition, the photoelectric conversion system 8 is connected to a control electronic control unit (ECU) 846 which is a control apparatus that outputs a control signal for generating a braking force on the vehicle based on a determination result of the collision determination unit 844. The photoelectric conversion system 8 is also connected to a warning apparatus 847 that issues a warning to a driver based on the determination result of the collision determination unit 844. For example, in a case where the determination result of the collision determination unit 844 indicates that the possibility of collision is high, the control ECU 846 performs vehicle control to avoid collision and reduce damage by applying a brake, returning an accelerator, reducing an engine output, or the like. The warning apparatus 847 issues a warning to a user by emitting warnings such as sound, displaying warning information on a screen of a car navigation system or the like, providing vibrations to a seat belt or a steering wheel, or the like.

In the present embodiment, the photoelectric conversion system 8 images the periphery of the vehicle, for example, an area in front of or behind the vehicle. FIG. 22C shows the photoelectric conversion system in the case of imaging the area (imaging range 850) in front of the vehicle. The vehicle information acquisition apparatus 845 sends an instruction to the photoelectric conversion system 8 or the photoelectric conversion apparatus 80. With such a configuration, accuracy of distance measurement can be further improved.

In the above description, an example of performing control to prevent collision with another vehicle has been described, but the present technology is also applicable to control for performing automated driving following another vehicle, control for performing automated driving so as not to stray from a lane, and the like. Furthermore, the photoelectric conversion system is not limited to the vehicle such as a car, and can be applied to the mobile body (mobile apparatus) such as a ship, an aircraft, or an industrial robot, for example. In addition, the present technology can be applied not only to the mobile body but also to equipment that widely uses object recognition, such as an intelligent transport system (ITS).

With the imaging system according to the above-described embodiment, a high-resolution image with a small amount of image distortion is displayed in the center region of the screen at which the user wants to gaze, and an image subjected to distortion correction processing is displayed in the peripheral region of the screen where visual sensitivity is low but which is useful for spatial perception. By performing different types of correction processing on the center region at which a human gazes and the peripheral region, respectively, the composition boundary can be made inconspicuous when the image of the center region and the image of the peripheral region are composited to generate the whole image. Therefore, the user can accurately recognize, for example, the surrounding situation in the mobile body without feeling unnaturalness, which can contribute to improvement of safety and the like.

The equipment according to the present embodiment can include at least one of an optical apparatus corresponding to the imaging system according to any one of the above-described embodiments, a control apparatus that controls the imaging system, and a processing apparatus that processes information obtained from the imaging system. Alternatively, at least one of the display apparatus that displays information obtained from the imaging system, the storage apparatus that stores information obtained from the imaging system, and the mechanical apparatus that operates based on information obtained from the imaging system can be included.

### Modifications

The present disclosure is not limited to the embodiments described above, and many modifications can be made within the technical idea of the present disclosure. For example, all or some of the different embodiments described above may be combined and implemented.

In the imaging system of the embodiment, before the center region (or the first region) and the peripheral region (or the second region) are extracted from the captured image, different types of correction processing or other image processing may be executed on partial images corresponding to the respective regions in the captured image. Thereafter, the center region (or the first region) and the peripheral region (or the second region) may be extracted, and the center region and the peripheral region may be composited to generate the whole image.

Alternatively, after the center region (or the first region) and the peripheral region (or the second region) are extracted from the captured image, different types of correction processing or other image processing may be executed on the respective extracted regions. Thereafter, the center region (or the first region) and the peripheral region (or the second region) may be composited to generate the whole image.

Alternatively, the center region (or the first region) and the peripheral region (or the second region) may be extracted from the captured image, the respective extracted regions may be composited to generate the whole image, and different types of correction processing or other image processing may be executed on partial images corresponding to the respective regions of the whole image obtained by the composition.

As other image processing, for example, coordinate transformation processing may be executed based on separately acquired distance information with respect to the subject to adjust an image composition position. Alternatively, object recognition processing or image processing for object detection processing may be executed.

The image processing executed for each region may be, for example, any one of or a combination of the noise reduction processing, luminance correction processing, contrast correction processing, the deformation processing for correcting the optical distortion of the captured image, and color balance correction processing, or may be other image processing.

Executing different types of correction processing as the first correction processing and the second correction processing may be, for example, an aspect of changing the execution intensity (for example, a value of a processing parameter) in the same type of processing, or an aspect of executing different types of processing in combination. In a case where the execution intensity (for example, the value of the processing parameter) is changed, an aspect in which substantially no correction is performed on one side, and correction is performed on the other side with any execution intensity may be applicable.

The application of the imaging system described in each embodiment is not limited to imaging. For example, the imaging system described in the embodiment is also applicable to a distance measurement apparatus (an apparatus for focus detection, distance measurement using time of flight (TOF), or the like), a photometric apparatus (an apparatus for measuring an incident light quantity or the like), or the like.

The photoelectric conversion apparatus used in the embodiment is not limited to a specific form, and may be, for example, any one of a front-illuminated type sensor and a back-illuminated type sensor. Alternatively, the photoelectric conversion apparatus may be a stacked-type photoelectric conversion apparatus in which a semiconductor chip including a light receiving unit and a semiconductor chip including an electric circuit such as a logic circuit are stacked.

A control program capable of executing a control method according to the above-described image processing (which includes extraction processing, correction processing, and composition processing for images of regions) and a computer-readable recording medium storing the control program are also included in the embodiments of the present disclosure.

The technology of the present disclosure can also be implemented by processing in which a program for implementing one or more functions of the embodiments is supplied to a system or an apparatus via a network or a storage medium, and one or more processors in a computer of the system or the apparatus read and execute the program. The technology of the present disclosure can also be implemented by a circuit (for example, an application specific integrated circuit (ASIC)) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033591, filed Mar. 4, 2025, which is hereby incorporated by reference herein in its entirety.

What is claimed is:

1. An imaging system comprising:
a first imaging apparatus;
a second imaging apparatus; and
an image generation unit configured to generate an image by using a signal output from each of the first imaging apparatus and the second imaging apparatus,
wherein the image generation unit is configured to:
generate a first region in the image by using first correction processing based on the signal output from one of the first imaging apparatus and the second imaging apparatus; and
generate a second region on an outer peripheral side of the first region in the image by using second correction processing different from the first correction processing based on the signal output from an other one of the first imaging apparatus and the second imaging apparatus.

2. The imaging system according to claim 1,
wherein the one of the first imaging apparatus and the second imaging apparatus is an imaging apparatus configured to perform imaging with a narrow angle of view.

3. The imaging system according to claim 1, wherein the image generation unit is configured to:
extract a first portion corresponding to the first region after executing the first correction processing on the signal output from the one of the first imaging apparatus and the second imaging apparatus;
extract a second portion corresponding to the second region after executing the second correction processing on the signal output from the other one of the first imaging apparatus and the second imaging apparatus; and
composite the first portion and the second portion to generate the image.

4. The imaging system according to claim 1, wherein the image generation unit is configured to:
extract a first portion corresponding to the first region from the signal output from the one of the first imaging apparatus and the second imaging apparatus and execute the first correction processing on the first portion that is extracted to generate the first region;
extract a second portion corresponding to the second region from the signal output from the other one of the first imaging apparatus and the second imaging apparatus and execute the second correction processing on the second portion that is extracted to generate the second region; and
composite the first region and the second region to generate the image.

5. The imaging system according to claim 1, wherein the image generation unit is configured to:
extract a first portion corresponding to the first region from the signal output from the one of the first imaging apparatus and the second imaging apparatus;
extract a second portion corresponding to the second region from the signal output from the other one of the first imaging apparatus and the second imaging apparatus;
composite the first portion and the second portion to generate a composite image; and
execute the first correction processing on a portion corresponding to the first region of the composite image and execute the second correction processing on a portion corresponding to the second region to generate the image.

6. An imaging system comprising:
an imaging apparatus configured to acquire a captured image having a different resolution per angle of view between a center region and a peripheral region; and
an image generation unit configured to generate an image by using the captured image,
wherein the image generation unit is configured to:
generate a first region in the image by using first correction processing for the center region of the captured image;
generate a second region in the image by using second correction processing different from the first correction processing for the peripheral region of the captured image; and
composite the first region and the second region to generate the image.

7. The imaging system according to claim 6, wherein the image generation unit is configured to
execute third correction processing different from the first correction processing and the second correction processing on an intermediate region between the center region and the peripheral region of the captured image to generate a third region between the first region and the second region in the image.

8. The imaging system according to claim 1,
wherein the first region is a rectangular or elliptical region.

9. The imaging system according to claim 1,
wherein each of the first correction processing and the second correction processing is any one of or a combination of noise reduction processing, luminance correction processing, contrast correction processing, deformation processing for correcting optical distortion of a captured image, and color balance correction processing.

10. The imaging system according to claim 1,
wherein the first correction processing is noise reduction processing, and the second correction processing is noise reduction processing whose noise reduction intensity is higher than a noise reduction intensity of the first correction processing.

11. The imaging system according to claim 1,
wherein the first correction processing is luminance correction processing, and the second correction processing is luminance correction processing having a gain different from a gain of the first correction processing.

12. The imaging system according to claim 1,
wherein the first correction processing is contrast correction processing, and the second correction processing is contrast correction processing having a gain different from a gain of the first correction processing.

13. The imaging system according to claim 1,
wherein the first correction processing is deformation processing for correcting optical distortion of a captured image, and the second correction processing is deformation processing whose distortion correction intensity is different from a distortion correction intensity of the first correction processing.

14. The imaging system according to claim 1,
wherein the first correction processing is color balance correction processing, and the second correction processing is color balance correction processing having a gain different from a gain of the first correction processing.

15. An imaging method in which an image generation unit generates an image by using a signal output from each of a first imaging apparatus and a second imaging apparatus, the imaging method comprising:
by the image generation unit,
generating a first region in the image by using first correction processing based on the signal output from one of the first imaging apparatus and the second imaging apparatus; and
generating a second region on an outer peripheral side of the first region in the image by using second correction processing different from the first correction processing based on the signal output from an other one of the first imaging apparatus and the second imaging apparatus.

16. An imaging method in which an image generation unit generates an image by using a signal output from an imaging apparatus configured to acquire a captured image having a different resolution per angle of view between a center region and a peripheral region, the imaging method comprising:
by the image generation unit,
generating a first region in the image by using first correction processing for the center region of the captured image;
generating a second region in the image by using second correction processing different from the first correction processing for the peripheral region of the captured image; and
compositing the first region and the second region to generate the image.

17. A non-transitory computer-readable recording medium storing a program for causing a computer to control each step of the imaging method according to claim 15.

18. A non-transitory computer-readable recording medium storing a program for causing a computer to control each step of the imaging method according to claim 16.
